(19) United States
(12) Patent Application Publication
(10) Pub. No.: US 2026/0095828 A1
(43) Pub. Date: Apr. 2, 2026

(54) METHODS AND APPARATUSES OF SUPPORTING SUBSEQUENT LTM

(71) Applicant: LENOVO (BEIJING) LIMITED, Beijing (CN)

(72) Inventors: Shuigen Yang, Shanghai (CN); Congchi Zhang, Shanghai (CN); Lianhai Wu, Beijing (CN); Mingzeng Dai, Shanghai (CN); Le Yan, Shanghai (CN); Bingchao Liu, Beijing (CN)

(21) Appl. No.: 19/113,477

(22) PCT Filed: Dec. 16, 2022
(86) PCT No.: PCT/CN2022/139567

§ 371 Date: Mar. 20, 2025

(51) Int. Cl. H04W 36/08; H04W 36/00

(52) U.S. Cl. CPC H04W 36/08; H04W 36/0061

(57) ABSTRACT

The present application relates to methods and apparatuses of supporting subsequent L1/L2-triggered mobility (LTM). An embodiment of the present disclosure provides a central unit (CU), comprising: a transceiver; and a processor coupled with the transceiver and configured to: determine a candidate cell configuration and an index of the candidate cell configuration for each candidate cell of one or more candidate cells, wherein the index of the candidate cell configuration for each candidate cell is generated by the CU, or received from a source distributed unit (DU), or from a candidate DU; transmit, to a user equipment (UE) via the source DU, a first message indicating the candidate cell configuration and the index of the candidate cell configuration for each candidate cell; transmit, to a source DU, a second message indicating the index of the candidate cell configuration for each candidate cell; and transmit, to a candidate DU, a third message indicating the index of the candidate cell configuration for each candidate cell.

### TECHNICAL FIELD

The present disclosure relates to wireless communication, and particularly relates to methods and apparatuses of supporting subsequent L1/L2-triggered mobility (LTM).

### BACKGROUND OF THE INVENTION

A user equipment (UE) may move from one cell to another cell, and thus at some points, a serving cell change needs to be performed.

At present, the serving cell change is performed by explicit radio resource control (RRC) reconfiguration signalling to trigger the synchronization of target cell based on layer 3 (L3) measurements report. It leads to longer latency, larger overhead, and longer interruption time than beam level mobility.

In 3rd generation partnership project (3GPP) Release 18, a new work item on further new radio (NR) mobility enhancements was approved to enable a serving cell change via lower layer signaling, e.g., layer 1 (L1) or layer 2 (L2) signalling, to reduce the latency, overhead and interruption time.

Thus, how to support subsequent LTM will be studied and solved.

### SUMMARY

One objective of the present disclosure is to propose to some solutions of supporting subsequent LTM.

An embodiment of the present disclosure provides a central unit (CU), comprising: a transceiver; and a processor coupled with the transceiver and configured to: determine a candidate cell configuration and an index of the candidate cell configuration for each candidate cell of one or more candidate cells, wherein the index of the candidate cell configuration for each candidate cell is generated by the CU, or received from a source distributed unit (DU), or from a candidate DU; transmit, to a UE via the source DU, a first message indicating the candidate cell configuration and the index of the candidate cell configuration for each candidate cell; transmit, to a source DU, a second message indicating the index of the candidate cell configuration for each candidate cell; and transmit, to a candidate DU, a third message indicating the index of the candidate cell configuration for each candidate cell.

In some embodiments, the one or more candidate cells include a candidate cell in the candidate DU.

In some embodiments, the one or more candidate cells further include a candidate cell in the source DU.

In some embodiments, the candidate cell in the source DU is a serving cell or a source cell, wherein the source cell is a cell in the source DU which is not the serving cell of the UE.

In some embodiments, the first message further includes an indicator indicating the UE to maintain the candidate cell configuration and the index of the candidate cell configuration for each candidate cell after an LTM cell switch.

In some embodiments, the second message further includes a candidate cell configuration in the candidate DU.

In some embodiments, the third message further includes at least one of the following: a serving cell configuration of a serving cell in the source DU; or a source cell configuration of a source cell in the source DU.

Another embodiment of the present disclosure provides a source DU, comprising: a transceiver; and a processor coupled with the transceiver and configured to: determine a candidate cell configuration and an index of the candidate cell configuration for each candidate cell of one or more candidate cells; transmit, to a UE, a first message indicating the candidate cell configuration and the index of the candidate cell configuration for each candidate cell; transmit, to a CU, a second message indicating the candidate cell configuration and the index of the candidate cell configuration for each candidate cell; and provide, to a candidate DU, the index of candidate cell configuration for each candidate cell.

In some embodiments, the one or more candidate cells include a candidate cell in the candidate DU.

In some embodiments, the one or more candidate cells further include a candidate cell in the source DU.

In some embodiments, the candidate cell in the source DU is a serving cell or a source cell, wherein the source cell is a cell in the source DU which is not the serving cell of the UE.

In some embodiments, the first message further includes an indicator indicating the UE to maintain the candidate cell configuration and the index of the candidate cell configuration for each candidate cell after an LTM cell switch.

In some embodiments, the processor is further configured to provide, to the candidate DU, at least one of the following: a serving cell configuration of a serving cell in the source DU; or a source cell configuration of a source cell in the source DU.

In some embodiments, the index of candidate cell configuration for candidate cell is provided to the candidate DU directly or via the CU.

Yet another embodiment of the present disclosure provides a candidate DU, comprising: a transceiver; and a processor coupled with the transceiver and configured to: determine a candidate cell configuration and an index of the candidate cell configuration for each candidate cell of one or more candidate cells; transmit, to a CU, a message indicating the candidate cell configuration and the index of the candidate cell configuration for each candidate cell; and provide, to a source DU, the index of the candidate cell configuration for each candidate cell.

In some embodiments, the one or more candidate cells include a candidate cell in the candidate DU.

In some embodiments, the one or more candidate cells further include a candidate cell in the source DU.

In some embodiments, the candidate cell in the source DU is a serving cell or a source cell, wherein the source cell is a cell in the source DU which is not the serving cell of the UE.

In some embodiments, the processor is further configured to provide, to the source DU, a candidate cell configuration of a candidate cell in the candidate DU.

In some embodiments, the index of the candidate cell configuration for each candidate cell is provided to the source DU directly or via the CU.

Still another embodiment of the present disclosure provides a UE comprising: a transceiver; and a processor coupled with the transceiver and configured to: receive a message indicating the candidate cell configuration and the index of the candidate cell configuration for each candidate cell; perform an LTM cell switch based on the message; and maintain the candidate cell configuration and the index of the candidate cell configuration for each candidate cell after the LTM cell switch.

In some embodiments, the one or more candidate cells include a candidate cell in the candidate DU.

In some embodiments, the one or more candidate cells further include a candidate cell in the source DU.

In some embodiments, the candidate cell in the source DU is a serving cell or a source cell, wherein the source cell is a cell in the source DU which is not the serving cell of the UE.

In some embodiments, the message includes an indicator indicating the UE to maintain the candidate cell configuration and the index of the candidate cell configuration for each candidate cell after the LTM cell switch.

Still another embodiment of the present disclosure provides a method performed by a CU, comprising: determining a candidate cell configuration and an index of the candidate cell configuration for each candidate cell of one or more candidate cells, wherein the index of the candidate cell configuration for each candidate cell is generated by the CU, or received from a source DU, or from a candidate DU; transmitting, to a UE via the source DU, a first message indicating the candidate cell configuration and the index of the candidate cell configuration for each candidate cell; transmitting, to a source DU, a second message indicating the index of the candidate cell configuration for each candidate cell; and transmitting, to a candidate DU, a third message indicating the index of the candidate cell configuration for each candidate cell.

Still another embodiment of the present disclosure provides a method performed by a source DU, comprising: determining a candidate cell configuration and an index of the candidate cell configuration for each candidate cell of one or more candidate cells; transmitting, to a UE, a first message indicating the candidate cell configuration and the index of the candidate cell configuration for each candidate cell; transmitting, to a CU, a second message indicating the candidate cell configuration and the index of the candidate cell configuration for each candidate cell; and providing, to a candidate DU, the index of the candidate cell configuration for each candidate cell.

Still another embodiment of the present disclosure provides a method performed by a candidate DU, comprising: determining a candidate cell configuration and an index of the candidate cell configuration for each candidate cell of one or more candidate cells; transmitting, to a CU, a message indicating the candidate cell configuration and the index of the candidate cell configuration for each candidate cell; and providing, to a source DU, the index of the candidate cell configuration for each candidate cell.

Still another embodiment of the present disclosure provides a method performed by a UE comprising: receiving a message indicating the candidate cell configuration and the index of the candidate cell configuration for each candidate cell; performing an LTM cell switch based on the message; and maintaining the candidate cell configuration and the index of the candidate cell configuration for each candidate cell after the LTM cell switch.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1A illustrates a schematic diagram of an intra-CU intra-DU mobility scenario according to some embodiments of the present disclosure.

FIG. 1B illustrates a schematic diagram of an intra-CU inter-DU mobility scenario according to some embodiments of the present disclosure.

FIG. 2 illustrates a method performed by a CU for supporting subsequent LTM according to some embodiments of the present disclosure.

FIG. 3 illustrates a method performed by a source DU for supporting subsequent LTM according to some embodiments of the present disclosure.

FIG. 4 illustrates a method performed by a candidate DU for supporting subsequent LTM according to some embodiments of the present disclosure.

FIG. 5 illustrates a method performed by a UE for supporting subsequent LTM according to some embodiments of the present disclosure.

FIG. 6 illustrates a flow chart of supporting subsequent LTM according to some embodiments of the present disclosure.

FIG. 7 illustrates a flow chart of supporting subsequent LTM according to some embodiments of the present disclosure.

FIG. 8 illustrates a flow chart of supporting subsequent LTM according to some embodiments of the present disclosure.

FIG. 9 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3GPP-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

The main objectives regarding further mobility enhancements may include:
Configuration and maintenance for multiple candidate cells to allow fast application of configurations for candidate cells.
Dynamic switch mechanism among candidate serving cells for the potential applicable scenarios.

The potential applicable scenarios of lower layer mobility may include intra-CU intra-DU mobility and intra-CU inter-DU mobility. In the present disclosure, the lower layer mobility is compared to the legacy L3 mobility based on RRC signalling, e.g., L1 or L2 mobility based on L1 or L2 signalling.

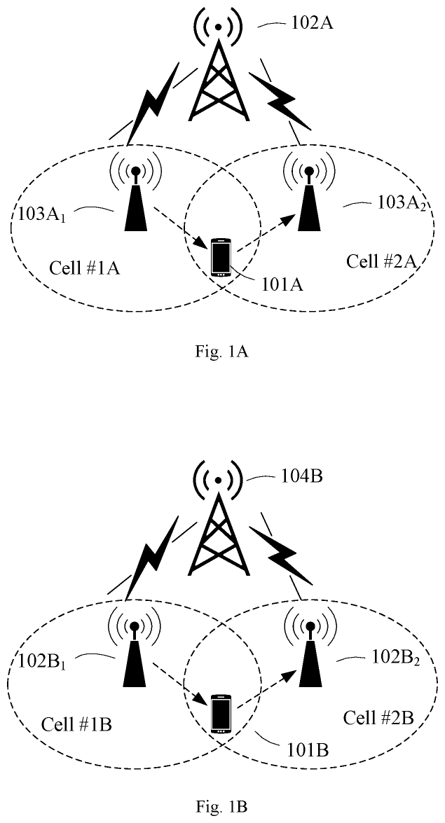

FIG. 1A illustrates a schematic diagram of an intra-CU intra-DU mobility scenario according to some embodiments of the present disclosure.

The wireless communication system in FIG. 1A includes a DU (e.g., DU 102A), a UE (e.g. UE 101A), and some access nodes (e.g. access node 103A₁ and access node 103A₂ ). The access node 103A₁ and access node 103A₂ are controlled by the DU 102A, and provides services for UEs within cell #1A and cell #2A respectively. Even though there are only one UE and two access nodes in FIG. 1A, persons skilled in the art will recognize that any number of UEs and access nodes may be included in the wireless communication system.

UE 101A may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, UE 101A may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE101A includes wearable devices, such as smart watches, fitness bands, optical head-mounted displays, or the like. Moreover, UE 101A may be referred to as subscriber units, mobiles, mobile stations, users, terminals, mobile terminals, wireless terminals, fixed terminals, subscriber stations, user terminals, a device, or by other terminology used in the art.

The access nodes 103A₁ and 103A₂ may be distributed over a geographic region. In certain embodiments, a access node may also be referred to as an access point, an access terminal, a base, a base station, a macro cell, a node-B, an enhanced node B (eNB), a gNB, a home node-B, a relay node, a device, or by any other terminology used in the art. The access nodes 103A₁ and 103A₂ may be generally a part of a radio access network that may include one or more controllers communicably coupled to one or more corresponding base stations.

The wireless communication system is compliant with any type of network that is capable of sending and receiving wireless communication signals. For example, the wireless communication system is compliant with a wireless communication network, a cellular telephone network, a TDMA-based network, a CDMA-based network, an OFDMA-based network, a long-term evolution (LTE) network, a 3GPP-based network, 3GPP 5G network, a satellite communications network, a high altitude platform network, and/or other communications networks.

In one implementation, the wireless communication system is compliant with the NR of the 3GPP protocol, wherein the transmission may be performed using an OFDM modulation scheme. More generally, the wireless communication system may implement some other open or proprietary communication protocol, for example, WiMAX, among other protocols.

In other embodiments, the transmission may be performed using other communication protocols, such as the IEEE 802.11 family of wireless communication protocols. Further, in some embodiments the transmission may be performed over licensed spectrum, while in other embodiments the transmission may be performed over unlicensed spectrum. The present disclosure is not intended to be limited to the implementation of any particular wireless communication system architecture or protocol. In another embodiment, the transmission may be performed using the 3GPP 5G protocols.

In FIG. 1A, UE 101A is moving from cell #1A to cell #2A, and may perform a handover procedure from cell #1A to access to cell #2A, which is a handover procedure performed between different cells within a DU. This scenario may be referred to as intra-CU intra-DU mobility. In short, this scenario may be called as intra-DU mobility.

FIG. 1B illustrates a schematic diagram of an intra-CU inter-DU mobility scenario according to some embodiments of the present disclosure.

The wireless communication system in FIG. 1B includes a CU (e.g., CU 104B), a UE (e.g. UE 101B), and some DUs (e.g. DU 102B₁ and DU 102B₂). The DU 102B₁ and DU 102B₂ are controlled by CU 104B, and provides services for UEs within cell #1B and cell #2B respectively. Even though there are only one UE and two DUs in FIG. 1B, persons skilled in the art will recognize that any number of UEs and DUs may be included in the wireless communication system.

In FIG. 1B, UE #101B is moving from cell #1B to cell #2B, and may perform a handover procedure from cell #1B to access to cell #2B, which is a handover procedure performed between different cells belonging to different DUs but within the same CU. This scenario may be referred to as intra-CU inter-DU mobility. In short, this scenario may be called as inter-DU mobility.

With LTM, the UE may obtain multiple candidate cell configurations before the cell switch via the RRC reconfiguration message. Based on the L1 measurement reports from the UE, the source DU may select one of the candidate cells as the target cell, and triggers the LTM cell switch by sending an index of the candidate cell configuration to the UE via medium access control-control element (MAC CE). Each index may be used to identify a candidate cell configuration for the UE. From the UE's perspective, an index indicating which candidate cell configuration should be applied (or used, activated, etc.) by the UE when the UE receives the LTM cell switch command (e.g. a MAC CE).

Currently, the UE may maintain the target cell configuration, and release other candidate cell configurations after the cell switch is triggered. Considering the complexity of candidate cell configuration preparation and handover latency, it is agreed to support subsequent LTM between candidate cells. Accordingly, the UE may not release other candidate cell configurations after an LTM cell switch is triggered and hence the LTM cell switch is supported without a RRC reconfiguration for handover preparation.

For the subsequent LTM, the following issues need to be addressed:

### Issue 1

The LTM cell switch may be triggered by the source DU via a MAC CE including the index of the candidate cell configuration. For subsequent LTM, the candidate DU(s) may not know the index of the candidate cell configuration stored by the UE. Furthermore, the candidate DU(s) and the UE may not have common understanding of the index of the candidate cell configuration.

### Issue 2

For subsequent LTM, the candidate cells may include the serving cell and the source cell in the source DU, and candidate cells in the candidate DU(s). Therefore, it is unclear which node may generate the index of the candidate cell configurations. It is also unclear how the candidate DU(s) knows the index of the serving cell configuration.

### Issue 3

For subsequent LTM, the UE may not be aware of whether to maintain or release the indexes and the corresponding cell configurations.

The present disclosure proposes some solutions at least for solving the above issues.

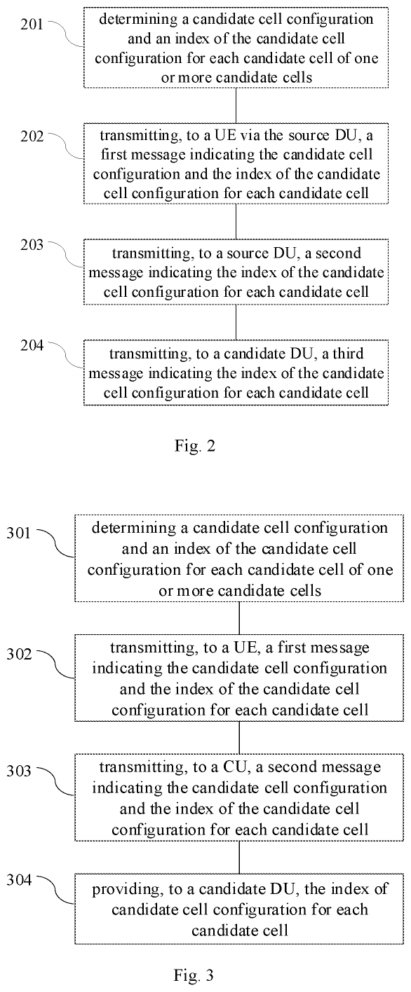

FIG. 2 illustrates a method performed by a CU for supporting subsequent LTM according to some embodiments of the present disclosure.

In operation 201, the CU may determine a candidate cell configuration and an index of the candidate cell configuration for each candidate cell of one or more candidate cells, wherein the index of the candidate cell configuration for each candidate cell is generated by the CU, or received from a source DU, or from a candidate DU. The source DU may also be referred to as a serving DU. The candidate DU may also be referred to as a target DU. In operation 202, the CU may transmit, to a UE via the source DU, a first message (for example, an RRC RECONFIGURATION message) indicating the candidate cell configuration and the index of the candidate cell configuration for each candidate cell. In operation 203, the CU may transmit, to a source DU, a second message (for example, a DL RRC MESSAGE TRANSFER message) indicating the index of the candidate cell configuration for each candidate cell; and in operation 204, the CU may transmit, to a candidate DU, a third message (for example, a DL RRC MESSAGE TRANSFER message) indicating the index of the candidate cell configuration for each candidate cell.

In some embodiments, the one or more candidate cells include a candidate cell in the candidate DU. In some embodiments, the one or more candidate cells further include a candidate cell in the source DU. In some embodiments, the candidate cell in the source DU is a serving cell or a source cell, wherein the source cell is a cell in the source DU which is not the serving cell of the UE.

In some embodiments, the first message further includes an indicator indicating the UE to maintain the candidate cell configuration and the index of the candidate cell configuration for each candidate cell after an LTM cell switch.

In some embodiments, the second message (for example, a DL RRC MESSAGE TRANSFER message) further includes a candidate cell configuration in the candidate DU. That is, the candidate cell configuration in the candidate DU may be transmitted to the source DU, thus the source DU is aware of the candidate cell configuration in the candidate DU.

In some embodiments, the third message (for example, a DL RRC MESSAGE TRANSFER message) further includes at least one of the following: a serving cell configuration of a serving cell in the source DU; or a source cell configuration of a source cell in the source DU. That is, the serving cell configuration and/or the source cell configuration in the source DU may be transmitted to the candidate DU, thus the candidate DU is aware of the candidate cell configurations in the source DU.

FIG. 3 illustrates a method performed by a source DU for supporting subsequent LTM according to some embodiments of the present disclosure.

In operation 301, the source DU may determine a candidate cell configuration and an index of the candidate cell configuration for each candidate cell of one or more candidate cells. In operation 302, the source DU may transmit, to a UE, a first message (for example, an RRC RECONFIGURATION message) indicating the candidate cell configuration and the index of the candidate cell configuration for each candidate cell. In operation 303, the source DU may transmit, to a CU, a second message (for example, a UE CONTEXT MODIFICATION RESPONSE message) indicating the candidate cell configuration and the index of the candidate cell configuration for each candidate cell. In operation 304, the source DU may provide, to a candidate DU, the index of candidate cell configuration for each candidate cell.

In some embodiments, the index of candidate cell configuration for candidate cell is provided to the candidate DU directly or via the CU.

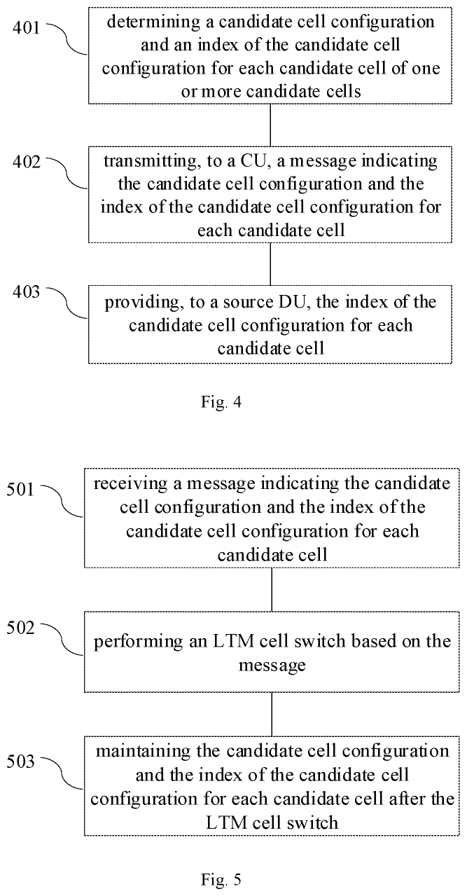

FIG. 4 illustrates a method performed by a candidate DU for supporting subsequent LTM according to some embodiments of the present disclosure.

In operation 401, the candidate DU may determine a candidate cell configuration and an index of the candidate cell configuration for each candidate cell of one or more candidate cells. In operation 402, the candidate DU may transmit, to a CU, a message (for example, a UE CONTEXT MODIFICATION RESPONSE message) indicating the candidate cell configuration and the index of the candidate cell configuration for each candidate cell. In operation 403, the candidate DU may provide, to a source DU, the index of the candidate cell configuration for each candidate cell.

In some embodiments, the index of candidate cell configuration for candidate cell is provided to the candidate DU directly or via the CU.

FIG. 5 illustrates a method performed by a UE for supporting subsequent LTM according to some embodiments of the present disclosure.

In operation 501, the UE may receive a message (for example, an RRC RECONFIGURATION message) indicating the candidate cell configuration and the index of the candidate cell configuration for each candidate cell. In operation 502, the UE may perform an LTM cell switch based on the message. In operation 503, the UE may maintain the candidate cell configuration and the index of the candidate cell configuration for each candidate cell after the LTM cell switch.

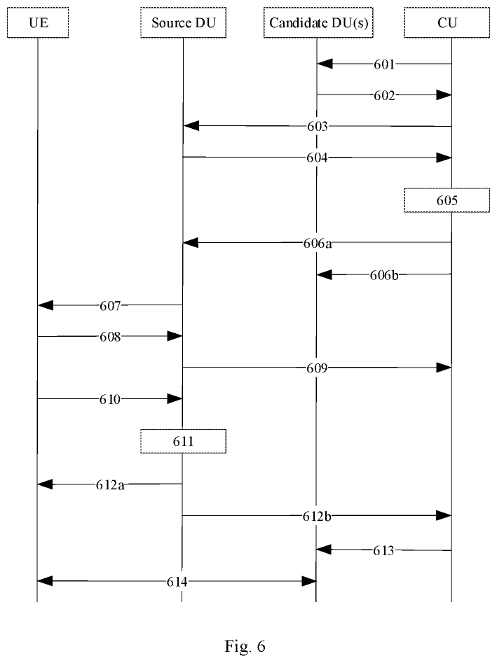

FIG. 6 illustrates a flow chart of supporting subsequent LTM according to some embodiments of the present disclosure.

In FIG. 6, there are: a UE, a source DU, one or more candidate DUs (which are referred to as “candidate DU(s) in FIG. 6), and a CU. The source DU and the one or more candidate DUs are within the CU, and the UE is moving from the source DU to one of the one or more candidate DUs. The source DU may manage (or control) the serving cell of the UE, and one or more source cells. The serving cell and the one or more source cells are considered as in the source DU. Hereinafter in the present disclosure, a source cell may refer to a cell in the source DU (or managed or controlled by the source DU), but is not a serving cell of the UE. Each candidate DU of the candidate DU(s) may manage one or more candidate cells, and the one or more candidate cells are considered as in each candidate DU. One of the one or more candidate DUs manages the candidate cell to which the UE is switched. In some embodiments, the candidate cell to which the UE is switched may be referred to as the “candidate target cell.”

In this solution, the index of the candidate cell configuration may be generated by the CU, and this solution may be applied to inter-DU scenario or intra-DU scenario. The source DU may provide the serving cell configuration and the source cell configuration(s) to the CU, and the candidate DU(s) (one or more candidate DUs) may provide the candidate cell configuration for each candidate cell that are controlled by the candidate DU(s) to the CU. In response to reception of the cell configuration of candidate cell(s) (in short, candidate cell configuration(s)), the cell configuration of source cell(s) (in short, source cell configuration(s)), and cell configuration of the serving cell (in short, serving cell configuration), the CU may determine (or generate, assign) an index for each candidate cell configuration (including the candidate cell configuration(s), the source cell configuration(s), and a serving cell configuration). The CU may send the indexes and the corresponding cell configurations to the UE, and may transmit the indexes of the corresponding cell configurations to the source DU and the candidate DU. The detailed flows are presented as follows.

In operation 601, the CU may transmit a message, e.g. a UE CONTEXT SETUP REQUEST message, indicating a number of candidate cell IDs (denoted as K candidate cell IDs for simplicity), to a candidate DU in the case that the K candidate cells are controlled by the same candidate DU; or to multiple candidate DUs in the case that the K candidate cells are controlled by the multiple candidate DUs candidate DU. The message(s) may request the preparation of the K candidate cells controlled by the candidate DU(s), to create a UE context and setup one or more data bearers.

In some embodiments, the UE CONTEXT SETUP REQUEST message may be sent for each candidate cell. That is, the CU may transmit K UE CONTEXT SETUP REQUEST messages, where each UE CONTEXT SETUP REQUEST message may indicate a candidate cell ID.

In some other embodiments, the UE CONTEXT SETUP REQUEST message may include multiple candidate cell IDs (e.g., a list of K candidate cell IDs), and is transmitted to the candidate DU(s) which controls and the multiple candidate cells.

In operation 602, at the candidate DU(s) side, among the K requested candidate cells, some may be accepted, while the other may not. It is supposed that the total number of accepted candidate cells is denoted as L simplicity, wherein L may be an integer equal to or larger than one, and L≤K. In some cases, the K requested candidate cells are all accepted. The candidate DU(s) may transmit a response message or multiple response messages to the CU, for example, one or more UE CONTEXT SETUP RESPONSE messages. The UE CONTEXT SETUP RESPONSE message(s) may indicate the candidate cell ID(s) of the L candidate cells that was requested from the CU, as well as the candidate cell configuration(s) corresponding to the candidate cell ID(s).

Each candidate cell configuration may include the cell configuration used for the LTM. For example, the candidate cell configuration may include at least one of the following:
A cell group configuration, which may be represented as: CellGroupConfig, and may contain the MAC entity, a set of logical channels with associated radio link control (RLC) entities, a primary cell and one or more secondary cells.
A radio bearer configuration, which may be represented as: RadioBearerConfig, and may contain the parameters for packet data convergence protocol (PDCP) and, if applicable, service data adaptation protocol (SDAP) entities for the radio bearers.
A measurements configuration, which may be represented as: MeasConfig, and may contain the configuration of measurements to be performed by the UE.
A multi-RAT dual connectivity (MRDC) secondary cell group configuration, which may be represented as: MRDC-SecondaryCellGroupConfig, and may contain the configuration for secondary cell group (SCG) configuration in dual connectivity (DC).
An ID of an SCell, which may be represented as: SCell ID, which is used to globally identify a cell.
An index of the SCell, which may be represented as: SCellIndex, which may be a short identity, used to identify an SCell. The value range is shared across the cell groups.

Hereinafter in the present disclosure, a cell configuration, such as a candidate cell configuration(s), a source cell configuration(s), or a serving cell configuration, may include at least one of the above information.

In some embodiments, the UE CONTEXT SETUP RESPONSE message may be sent for each requested candidate cell, i.e., each UE CONTEXT SETUP RESPONSE message for one candidate cell, and the candidate DU(s) may send L UE CONTEXT SETUP RESPONSE messages to the CU. In some other embodiments, in the case there is only one candidate DU, the one candidate DU may transmit one UE CONTEXT SETUP RESPONSE message indicating L candidate cell configurations. In some other embodiments, each candidate DU of the multiple DUs may transmit one UE CONTEXT SETUP RESPONSE message indicating all requested candidate cell configurations of itself to the CU.

In operation 603, the CU may transmit a message, e.g. a UE CONTEXT MODIFICATION REQUEST message to the source DU, which may indicate a number of candidate cell IDs (denoted as X candidate cell IDs for simplicity, wherein X may be an integer equal to or larger than one). The message may modify the UE context. The candidate cell in the source DU may refer to the source cell in the source DU, or the serving cell in the source DU.

In some embodiments, the UE CONTEXT MODIFICATION REQUEST message may be sent for each candidate cell. That is, the CU may transmit X UE CONTEXT MODIFICATION REQUEST messages to the source DU, wherein each UE CONTEXT MODIFICATION REQUEST message may indicate a candidate cell ID.

In some other embodiments, the CU may transmit one UE CONTEXT MODIFICATION REQUEST message, which may include multiple candidate cell IDs (e.g., a list of X candidate cell IDs), to the source DU.

In operation 604, among the X requested candidate cells, some may be accepted, while the other may not. It is supposed that the total number of accepted candidate cells is denoted as Y simplicity, wherein Y may be an integer equal to or larger than one, and Y≤X. In some cases, the X requested candidate cells are all accepted. In some cases, the X requested candidate cells may include the serving cell of the UE, in other cases, the X requested candidate cells may not include the serving cell of the UE.

The source DU may transmit a response message to the CU, for example, a UE CONTEXT MODIFICATION RESPONSE message. The UE CONTEXT MODIFICATION RESPONSE message may indicate the candidate cell ID(s) that was requested from the CU (for example, the IDs of the Y accepted candidate cells), as well as the candidate cell configuration corresponding to the candidate cell ID(s). Since the candidate cells in the source DU may include a serving cell and one or more source cells, the UE CONTEXT MODIFICATION RESPONSE message may indicate the ID(s) of the one or more source cell in the source DU, as well as the one or more source cell configurations corresponding to the ID(s). The UE CONTEXT MODIFICATION RESPONSE message may also indicate the ID of the serving cell in the source DU, as well as the serving cell configuration.

In operation 605, after receiving the L candidate cell configurations from the candidate DU(s) and the Y candidate cell configurations from the source DU, the CU may determine (or assign, generate, etc.) an index for each candidate cell configuration of a total number of (denoted as M for simplicity) candidate cell configurations, where the index is used to identify a candidate cell configuration. When the Y candidate cell configurations includes the serving cell configuration, M=L+Y; when the Y candidate cell configurations does not includes the serving cell configuration, M =L+Y+1. There are M determined indexes in total.

The index may be a numerical value, e.g., 0, 1, 2, 3, etc. The maximum value of the index may be pre-configured, such as 8, 16, 32, 64, 128, etc. Alternatively, the index may be a candidate cell configuration ID, which is used to identify a candidate cell configuration.

In operation 606a, the CU may transmit a message to the source DU, which may include the M indexes and a generated RRC RECONFIGURATION message. The message may be a UE CONTEXT MODIFICATION REQUEST message, a DL RRC MESSAGE TRANSFER message, or other messages.

The M indexes may include at least one of the following:
The index(es) for the candidate cell configuration(s);
The index(es) for the source cell configurations(s); or
An index for the serving cell configuration.

The RRC RECONFIGURATION message, which is transmitted to the UE, may include M indexes and the cell configurations corresponding to the M indexes.

In some embodiments, the RRC RECONFIGURATION message may also include an indicator which indicates the cell configuration(s) and the index(es) should be maintained by the UE after the LTM cell switch.

For example, the RRC RECONFIGURATION message includes a field named as “subsequent LTM”. If the field is set to true, or with a value “1”, the UE may maintain the cell configurations and the indexes after the LTM cell switch. The field may be referred to as other names.

In some other cases, the UE may be configured to maintain the cell configuration(s) and the index(es) after the LTM cell switch by predefined rules, by specification, etc. That is, there is no indicator indicating the UE to maintain the cell configurations and the indexes after the LTM cell switch, and the UE may still maintain the cell configurations and the indexes after the LTM cell switch.

In some embodiments, the message, e.g. a UE CONTEXT MODIFICATION REQUEST message, or a DL RRC MESSAGE TRANSFER message, may further include the candidate cell configuration(s).

In operation 606b, the CU may transmit a message including the M indexes to the candidate DU(s). The message may be a UE CONTEXT MODIFICATION REQUEST message or a DL RRC MESSAGE TRANSFER message, or other messages. In some embodiments, the message may further include the serving cell configuration, the source cell configuration(s), or both. In some cases, the CU may not provide the M indexes, the serving cell configuration, and/or the source cell configuration(s), to the candidate DU(s) in operation 606b, and may provide the M indexes, the serving cell configuration, and/or the source cell configuration(s), to the candidate DU(s) in operation 613.

In operation 607, the source DU may store the M indexes for the cell configurations and may forward the RRC RECONFIGURATION message to the UE.

In operation 608, the UE may transmit a message, e.g. a RRC RECONFIGURATION COMPLETE message, as a response to the source DU.

In operation 609, the source DU may forward the RRC RECONFIGURATION COMPLETE message to the CU via an UL RRC MESSAGE TRANSFER message, or a UE CONTEXT MODIFICATION RESPONSE message, or other messages.

In operation 610, the UE may start to report the L1 measurements of serving cell, the source cell, and/or the candidate cells.

In operation 611, the source DU may determine that the LTM cell switch to a candidate cell is needed.

In operation 612a, the source DU may send an LTM cell switch command (e.g., MAC CE) to the UE, to trigger the UE to change from the current serving cell to a candidate cell, hereinafter referred to as candidate cell 1 for clarity.

In operation 612b, the source DU may send an LTM cell switch command report to the CU, which may include the candidate cell identity to which the LTM cell switch was initiated toward, e.g. the identify of candidate cell 1.

In operation 613, the CU may send a message to the candidate DU, and the message may include the M indexes of the candidate cell configurations, the serving cell configuration, and/or the source cell configuration(s). The message may be a DL RRC MESSAGE TRANSFER message, a UE CONTEXT MODIFICATION REQUEST message, or other messages. In some cases, the CU may not provide the M indexes to the candidate DU(s) in operation 613.

In operation 614, an access procedure may be performed between the UE and the candidate DU that controls candidate cell 1.

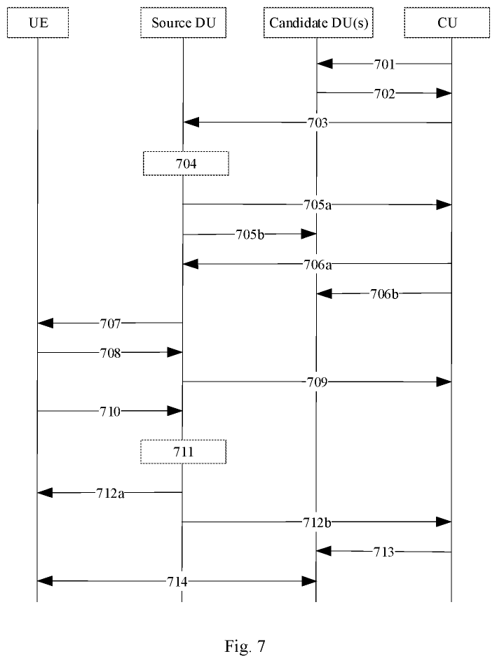

FIG. 7 illustrates a flow chart of supporting subsequent LTM according to some embodiments of the present disclosure.

FIG. 7 includes the same components as described in FIG. 6, and details are omitted here.

In this solution, the index of the candidate cell configuration may be generated by the source DU, and this solution may be applied to inter-DU scenario or intra-DU scenario. The candidate DU may provide the candidate cell configuration(s) to the source DU directly or via the CU. The source DU may determine (or generate, assign) an index for each candidate cell configuration, an index for each source cell configuration, and an index for the serving cell configuration. Then, the source DU may send the indexes and the corresponding cell configurations (including the candidate cell configurations, source cell configurations, and serving cell configuration) to the CU. The CU may send the indexes and the corresponding cell configurations to the UE, and may send the indexes of the corresponding cell configurations to the candidate DU. Alternatively, the source DU may send indexes of the corresponding cell configurations to the candidate DU directly. The detailed flows are presented as follows.

Operations 701 and 702 are similar to operations 601 and 602 respectively, and details are omitted here.

In operation 703, the CU may transmit a message, e.g. a UE CONTEXT MODIFICATION REQUEST message, to the source DU, which may indicate X candidate cell ID(s) in the source DU and L candidate cell configuration(s) in the candidate DU(s).

In some embodiments, the UE CONTEXT MODIFICATION REQUEST message may be sent for each candidate cell. That is, the CU may transmit X UE CONTEXT MODIFICATION REQUEST messages to the source DU, wherein each UE CONTEXT MODIFICATION REQUEST message may indicate a candidate cell ID.

In some other embodiments, the CU may transmit one UE CONTEXT MODIFICATION REQUEST message, which may include multiple candidate cell IDs (e.g., a list of X candidate cell IDs), to the source DU.

The X candidate cells may include the candidate cells which are not the serving cell of the UE in the source DU, that is, the X candidate cells may only include the source cells; alternatively, the X candidate cells may include serving cell of the UE in the source DU. That is, the X candidate cells may include a serving cell and X-1 source cells.

Among the X requested candidate cells, some may be accepted, while the other may not. It is supposed that the total number of accepted candidate cells is denoted as Y simplicity, wherein Y may be an integer equal to or larger than one, and Y≤X. In some cases, the X requested candidate cells are all accepted. In some cases, the X requested candidate cells may include the serving cell, in other cases, the X requested candidate cells may not include the serving cell.

In some cases, the candidate DU(s) may transmit the L candidate cell configuration(s) in the candidate DU(s) to the source DU directly.

In operation 704, the source DU may determine (or assign, generate, etc.) an index for each candidate cell configuration of a total number (denoted as M for simplicity) of candidate cell configurations, where the index is used to identify a candidate cell configuration. The M cell configurations may include the candidate cell configuration(s), the source cell configuration(s), the serving cell configuration, or any combination thereof.

In operation 705a, the source DU may transmit one or more messages, e.g. one or more UE CONTEXT MODIFICATION RESPONSE messages, as a response to the CU, which may include the M cell configurations (including the candidate cell configuration(s), source cell configuration(s) and/or a serving cell configuration) and the corresponding M indexes.

The M indexes may include at least one of the following:
The index(es) for the candidate cell configuration(s);
The index(es) for the source cell configurations(s); or
An index for the serving cell configuration.

The UE CONTEXT MODIFICATION RESPONSE message may be sent for each of the M candidate cells, thus there are M UE CONTEXT MODIFICATION RESPONSE messages, each indicating one index and a corresponding cell configuration. Alternatively, one UE CONTEXT MODIFICATION RESPONSE message may include a list of M cell configurations and the corresponding indexes.

In some embodiments, in operation 705b, the source DU may transmit a message to the candidate DU(s), which may indicate the M indexes to the candidate DU(s). In some cases, the message may further include the serving cell configuration, the source cell configuration(s), or both. In some embodiments, the source DU may not be able to transmit the message to the candidate DU(s), thus operation 705b may not be performed.

In operation 706a, the CU may send a DL RRC MESSAGE TRANSFER message to the source DU, which includes a generated RRC RECONFIGURATION message. The generated RRC RECONFIGURATION message may include M indexes and the corresponding cell configurations.

In some embodiments, the RRC RECONFIGURATION message may also include an indicator which indicates the cell configurations and the indexes should be maintained by the UE. That is, the index(es) and the corresponding cell configuration(s) should be maintained by the UE after the LTM cell switch.

For example, the RRC RECONFIGURATION message includes a field named as “subsequent LTM”. If the field is set to true, or with a value “1”, the UE may maintain the cell configurations and the indexes after the LTM cell switch.

In some other cases, the UE may be configured to maintain the cell configurations and the indexes after the LTM cell switch by predefined rules, by specification, etc.

In some cases, the message, e.g., a DL RRC MESSAGE TRANSFER message, may further include the candidate cell configuration(s).

In operation 706b, the CU may transmit a message including the M indexes to the candidate DU(s). The message may be a UE CONTEXT MODIFICATION REQUEST message or a DL RRC MESSAGE TRANSFER message, or other messages. In some cases, the message may further include the serving cell configuration, the source cell configuration(s), or both.

Operations 707 to 714 are similar to operations 607 to 614 respectively, and details are omitted here.

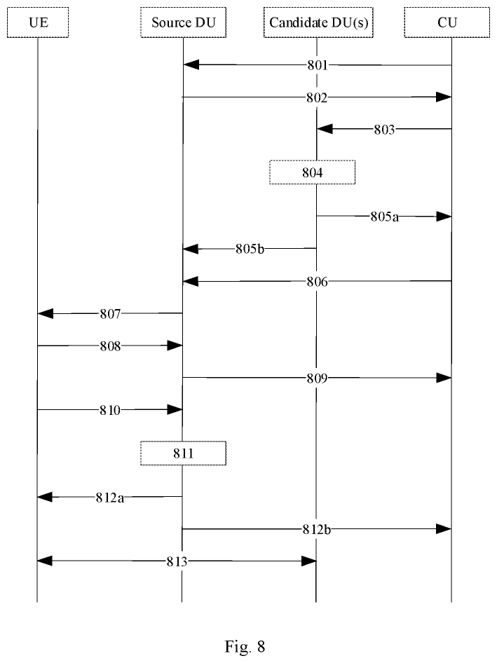

FIG. 8 illustrates a flow chart of supporting subsequent LTM according to some embodiments of the present disclosure.

FIG. 8 includes the same components as described in FIG. 6, and details are omitted here.

In this solution, the index of the candidate cell configuration may be generated by a candidate DU, and this solution may be applied to inter-DU scenario or intra-DU scenario. The source DU may provide the source cell configuration(s) and optionally the serving cell configuration to the candidate DU directly or via the CU. The candidate DU may determine (or generate, assign) an index for each candidate cell configuration, each source cell configuration, and the serving cell configuration. Then, the candidate DU may send the indexes and the corresponding cell configurations (including the candidate cell configuration(s), the source cell configuration(s), and a serving cell configuration) to the CU. The CU may send the indexes and the corresponding cell configurations to the UE, and may send the indexes of the corresponding cell configurations to the source DU. Alternatively, the candidate DU may send indexes of the corresponding cell configurations to the source DU directly. The detailed flows are presented as follows.

Operations 801 and 802 are similar to operations 603 and 604 respectively, and details are omitted here.

In operation 803, the CU may transmit a message, e.g. a UE CONTEXT SETUP REQUEST message, indicating a number of candidate cell IDs (denoted as K candidate cell IDs for simplicity), to a candidate DU in the case that the K candidate cells are controlled by the same candidate DU; or to multiple candidate DUs in the case that the K candidate cells are controlled by the multiple candidate DUs. The message may request the preparation of K candidate cells controlled by the candidate DU(s), to create a UE context and setup one or more data bearers.

In some embodiments, the UE CONTEXT SETUP REQUEST message may be sent for each candidate cell. That is, the CU may transmit K UE CONTEXT SETUP REQUEST messages, where each UE CONTEXT SETUP REQUEST message may indicate a candidate cell ID.

In some other embodiments, the UE CONTEXT SETUP REQUEST message may include multiple candidate cell IDs (e.g., a list of K candidate cell IDs), and is transmitted to the candidate DU(s) which controls and the multiple candidate cells.

The UE CONTEXT SETUP REQUEST message may also include Y candidate cell configurations in the source DU, which may include the source cell configuration(s), the serving cell configuration, or both.

In some cases, the source DU may transmit the Y candidate cell configuration(s) to the candidate DU directly.

In operation 804, the preparation request may be accepted, and among the K requested candidate cells, L requested candidate cells may be accepted, wherein L may be an integer equal to or larger than one, and L≤K. The candidate DU may determine (or assign, generate, etc.) an index for each candidate cell configuration of a total number of (denoted as M for simplicity) candidate cell configurations, where the index is used to identify a candidate cell configuration.

In operation 805a, the candidate DU may transmit a message, e.g. a UE CONTEXT SETUP RESPONSE message, as a response to the CU, which may include the M cell configurations and the corresponding M indexes.

The M indexes may include at least one of the following:
The index(es) for the candidate cell configuration(s);
The index(es) for the source cell configurations(s); or
An index for the serving cell configuration.

In some embodiments, in operation 805b, the candidate DU may transmit a message to the source DU, which may indicate the M indexes to the source DU(s). In some cases, the message may further include the candidate cell configuration(s). In some embodiments, the candidate DU may not be able to transmit the message to the source DU, thus operation 805b may not be performed.

Operations 806 to 813 are similar to operations 606a, 607 to 612, and 614 respectively, and details are omitted here.

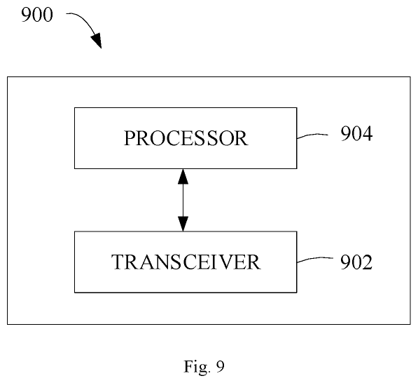

FIG. 9 illustrates a simplified block diagram of an apparatus according to some embodiments of the present disclosure.

As shown in FIG. 9, an example of the apparatus 900 may include at least one processor 904 and at least one transceiver 902 coupled to the processor 904. The apparatus 900 may be a UE, a BS, a CU, a candidate DU, a source DU, a target DU, or any other device with similar functions.

Although in this figure, elements such as the at least one transceiver 902 and processor 904 are described in the singular, the plural is contemplated unless a limitation to the singular is explicitly stated. In some embodiments of the present disclosure, the transceiver 902 may be divided into two devices, such as a receiving circuitry and a transmitting circuitry. In some embodiments of the present disclosure, the apparatus 900 may further include an input device, a memory, and/or other components.

In some embodiments of the present disclosure, the apparatus 900 may be a UE. The transceiver 902 and the processor 904 may interact with each other so as to perform the operations of the UE described in any of FIGS. 1-8. In some embodiments of the present disclosure, the apparatus 900 may be a CU, a candidate DU, a source DU, a target DU, or the like. The transceiver 902 and the processor 904 may interact with each other so as to perform the operations of the CU or DU(s) described in any of FIGS. 1-8.

In some embodiments of the present disclosure, the apparatus 900 may further include at least one non-transitory computer-readable medium.

For example, in some embodiments of the present disclosure, the non-transitory computer-readable medium may have stored thereon computer-executable instructions to cause the processor 904 to implement the method with respect to the UE as described above. For example, the computer-executable instructions, when executed, cause the processor 904 interacting with transceiver 902 to perform the operations of the UE described in any of FIGS. 1-8.

In some embodiments of the present disclosure, the non-transitory computer-readable medium may have stored thereon computer-executable instructions to cause the processor 904 to implement the method with respect to a CU, a candidate DU, a source DU, a target DU, or a candidate DU as described above. For example, the computer-executable instructions, when executed, cause the processor 904 interacting with transceiver 902 to perform the operations of the CU or DU(s) described in any of FIGS. 1-8.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “including.”

1. A central unit (CU), comprising:
at least one memory; and
at least one processor coupled with the at least one memory and configured to cause the CU to:
determine a candidate cell configuration and an index of the candidate cell configuration for each candidate cell of one or more candidate cells, wherein the index of the candidate cell configuration for each candidate cell is generated by the CU, or received from a source distributed unit (DU), or from a candidate DU;
transmit, to a user equipment (UE) via the source DU, a first message indicating the candidate cell configuration and the index of the candidate cell configuration for each candidate cell;
transmit, to a source DU, a second message indicating the index of the candidate cell configuration for each candidate cell; and
transmit, to a candidate DU, a third message indicating the index of the candidate cell configuration for each candidate cell.

2. The CU of claim 1, wherein the one or more candidate cells include a candidate cell in the candidate DU.

3. The CU of claim 2, wherein the one or more candidate cells further include a candidate cell in the source DU.

4. The CU of claim 3, wherein the candidate cell in the source DU is a serving cell or a source cell, wherein the source cell is a cell in the source DU which is not the serving cell of the UE.

5. The CU of claim 1, wherein the first message further includes an indicator indicating the UE to maintain the candidate cell configuration and the index of the candidate cell configuration for each candidate cell after an L1/L2-Triggered mobility (LTM) cell switch.

6. The CU of claim 1, wherein the second message further includes a candidate cell configuration in the candidate DU.

7. The CU of claim 1, wherein the third message further includes at least one of the following:
a serving cell configuration of a serving cell in the source DU; or a source cell configuration of a source cell in the source DU.

8. A source distributed unit (DU), comprising:
at least one memory; and
at least one processor coupled with the at least one memory and configured to cause the source DU to:
determine a candidate cell configuration and an index of the candidate cell configuration for each candidate cell of one or more candidate cells;
transmit, to a user equipment (UE), a first message indicating the candidate cell configuration and the index of the candidate cell configuration for each candidate cell;
transmit, to a central unit (CU), a second message indicating the candidate cell configuration and the index of the candidate cell configuration for each candidate cell; and
provide, to a candidate DU, the index of candidate cell configuration for each candidate cell.

9. The source DU of claim claim 8, wherein the one or more candidate cells include a candidate cell in the candidate DU.

10. The source DU of claim claim 9, wherein the one or more candidate cells further include a candidate cell in the source DU.

11. The source DU of claim claim 10, wherein the candidate cell in the source DU is a serving cell or a source cell, and wherein the source cell is a cell in the source DU which is not the serving cell of the UE.

12. The source DU of claim claim 8, wherein the first message further includes an indicator indicating the UE to maintain the candidate cell configuration and the index of the candidate cell configuration for each candidate cell after an L1/L2-Triggered mobility (LTM) cell switch.

13. The source DU of claim claim 8, wherein the at least one processor is configured to cause the source DU to provide, to the candidate DU, at least one of the following:
a serving cell configuration of a serving cell in the source DU; or a source cell configuration of a source cell in the source DU.

14. The source DU of claim claim 8, wherein the index of candidate cell configuration for candidate cell is provided to the candidate DU directly or via the CU.

15. A user equipment (UE), comprising:
at least one memory; and
at least one processor coupled with the at least one memory and configured to cause the UE to:
receive a message indicating a candidate cell configuration and an index of the candidate cell configuration for each candidate cell;
perform an L1/L2-Triggered mobility (LTM) cell switch based on the message; and
maintain the candidate cell configuration and the index of the candidate cell configuration for each candidate cell after the LTM cell switch.

12. A method performed by a central unit (CU), the method comprising:
determining a candidate cell configuration and an index of the candidate cell configuration for each candidate cell of one or more candidate cells, wherein the index of the candidate cell configuration for each candidate cell is generated by the CU, or received from a source distributed unit (DU), or from a candidate DU;
transmitting, to a user equipment (UE) via the source DU, a first message indicating the candidate cell configuration and the index of the candidate cell configuration for each candidate cell;
transmitting, to a source DU, a second message indicating the index of the candidate cell configuration for each candidate cell; and
transmitting, to a candidate DU, a third message indicating the index of the candidate cell configuration for each candidate cell.

17. The method of claim 16, wherein the one or more candidate cells include a candidate cell in the candidate DU.

18. The method of claim 17, wherein the one or more candidate cells further include a candidate cell in the source DU.

19. The method of claim 18, wherein the candidate cell in the source DU is a serving cell or a source cell, wherein the source cell is a cell in the source DU which is not the serving cell of the UE.

20. The method of claim 16, wherein the first message further includes an indicator indicating the UE to maintain the candidate cell configuration and the index of the candidate cell configuration for each candidate cell after an L1/L2-Triggered mobility (LTM) cell switch.
